(19) United States
(12) Patent Application Publication
(10) Pub. No.: US 2023/0160591 A1
(43) Pub. Date: May 25, 2023

(54) BUILDING MANAGEMENT SYSTEM WITH EXPIRED OPERATIONAL CERTIFICATE RECOVERY

(71) Applicant: Johnson Controls Tyco IP Holdings LLP, Milwaukee, WI (US)

(72) Inventors: Brandon A. Sloat, New Berlin, WI (US); Mark Hansen, Wauwatosa, WI (US); Donald A. Gottschalk, Racine, WI (US); Brandon Michael DuPrey, Waukesha, WI (US); Anthony Louis Miller, West Allis, WI (US)

(73) Assignee: Johnson Controls Tyco IP Holdings LLP, Milwaukee, WI (US)

(21) Appl. No.: 17/531,474

(22) Filed: Nov. 19, 2021

(51) Int. Cl. F24F 11/56; F24F 11/49; F24F 11/48

(52) U.S. Cl. CPC F24F 11/56; F24F 11/49; F24F 11/48

(57) ABSTRACT

Methods and systems for reconnecting a device with an expired device operational certificate in a building management system (BMS) are disclosed. One method includes identifying that a device operational certificate of a first device has expired, sending an instruction to a second device to accept the expired device operational certificate as valid, receipt of the instruction causing the second device to relax an expiration date and accept the expired device operational certificate as valid, and delivering a replacement device operational certificate to the first device to replace the expired device operational certificate.

### BACKGROUND

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, and any other system that is capable of managing building functions or devices, or any combination thereof. A BMS may include a variety of field devices (e.g., HVAC devices, controllers, chillers, fans, sensors, etc.) configured to facilitate monitoring and controlling building spaces. Field devices can be configured to communicate with other devices via a network, such as a Building Automation and Control network (BACnet) or a Local Area Network and from potential external attacks.

A BMS may employ a secure protocol such as a standard TLS protocol to protect the field devices and the system from cyberattacks. Devices in the BMS include a stored digital operational certificate which permits communication between devices in the BMS. The devices mutually authenticate each other's certificate to determine whether to trust the other and allow communication. In some circumstances, the certificate may expire, thus preventing a device from communicating with other devices in the BMS in the manner required to carry out its functions. The expiration of an operational certificate generally requires a technician to go to the device and physically perform a factory reset in order for the device to receive a renewed operational certificate. Field devices may be in remote areas and difficult to access. As such, it would be advantageous for a device in a BMS to communicate with the other devices for a period of time using an expired certificate and to replace the expired operational certificate without the need for a physical factory reset.

### SUMMARY

One implementation of the present disclosure relates to a method of reconnecting a device with an expired device operational certificate in a building management system (BMS). The method includes identifying that a device operational certificate of a first device has expired, sending an instruction to a second device to accept the expired device operational certificate as valid, receipt of the instruction causing the second device to relax an expiration date and accept the expired device operational certificate as valid, and delivering a replacement device operational certificate to the first device to replace the expired device operational certificate.

In some embodiments, the method further includes receiving an indication from the second device that each of one or more other attributes of the device operational certificate indicate that the device operational certificate would otherwise be valid if not for being expired, wherein accepting the expired operational certificate as valid is performed in response to determining that the certificate would have otherwise been valid if not for being expired.

In some embodiments, the one or more other attributes comprise the device operational certificate being well formed, the device operational certificate not having been revoked, or the device operational certificate having been signed by a locally configured certificate authority (CA).

In some embodiments, identifying that the device operational certificate of the first device has expired comprises receiving an indication from the first device or second device that the device operational certificate has expired.

In some embodiments, relaxing the expiration date to accept the expired device operational certificate as valid comprises one of removing an expiration date to accept an expired operational certificate or adjusting the expiration date to accept an operational certificate that is expired by less than a predetermined amount of time.

In some embodiments, delivering the replacement device operational certificate to the first device to replace the expired device operational certificate comprises retrieving the replacement device operational certificate from a locally configured CA.

In some embodiments, the method further includes resetting a connection between the first device and the second device, and validating the replacement device operational certificate.

In some embodiments, sending an instruction to the second device comprises sending an allowable expired list of device operational certificate fingerprints that are acceptable even if expired.

Another implementation of the present disclosure relates to BMS that includes a first device comprising a device operational certificate and a second device comprising one or more processors and one or more computer-readable storage media having instructions stored thereon. When executed by the one or more processors, the instructions cause the one or more processors to implement operations comprising identifying that the device operational certificate of the first device has expired, receiving an instruction to accept the expired device operational certificate as valid, and relaxing an expiration date requirement to accept the expired device operational certificate as valid.

In some embodiments the operations further include confirming that each of one or more other attributes of the device operational certificate indicate that the device operational certificate is valid.

In some embodiments, the one or more other attributes comprise the device operational certificate being well formed, the device operational certificate not having been revoked, or the device operational certificate having been signed by a locally configured certificate authority (CA).

In some embodiments, identifying that the device operational certificate of the first device has expired comprises receiving, from the first device, a fingerprint of the device operational certificate.

In some embodiments, relaxing the expiration date requirement to accept the expired device operational certificate as valid comprises one of removing an expiration date to accept an expired operational certificate or adjusting the expiration date to accept an operational certificate that is expired by less than a predetermined amount of time.

In some embodiments, the BMS further comprises a user interface device comprising a user interface configured to display a plurality of icons, each corresponding to one of one or more devices and configured to indicate a connection status of each of the one or more devices.

In some embodiments, the user interface device is configured to send an instruction to one or more devices in the BMS to accept the expired device operational certificate as valid.

In some embodiments, receiving an instruction to accept the expired device operational certificate as valid comprises receiving an allowable expired list of device operational certificate fingerprints that are acceptable even if expired.

Another implementation of the present disclosure relates to a method of replacing an expired device operational certificate. The method includes identifying that a device operational certificate of a first device has expired, receiving an instruction from a user interface device to accept the device operational certificate that has expired as valid, relaxing an expiration date requirement and accepting the expired device operational certificate as valid, receiving a replacement device operational certificate from the user interface device, and delivering the replacement device operational certificate to the first device.

In some embodiments, receiving an instruction from a user interface device to accept the device operational certificate that has expired as valid comprises receiving an allowable expired list of device operational certificate fingerprints that are acceptable even if expired.

In some embodiments, the method further includes confirming that the replacement device operational certificate is valid.

In some embodiments, the method further includes communicatively connecting to the first device in response to confirming that the replacement device operational certificate is valid.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS) and a HVAC system, according to some embodiments.

FIG. 2 is a block diagram of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is a flow diagram of an example process for mutual TLS authentication of operational certificates between a field device and an engine, according to some embodiments.

FIGS. 6A-6C are block diagrams of a portion of a BMS illustrating a process for instructing devices in the BMS to accept an expired operational certificate according to some embodiments.

FIG. 7 is a flow diagram of an example process for replacing an expired operational certificate on a device, according to some embodiments.

FIG. 8 is a block diagram of the workflow and object interaction between an engine and a plurality of field devices, according to some embodiments.

FIG. 9 is a block diagram of the workflow and object interaction between an engine and a plurality of field devices during the replacement of an expired operational certificate, according to some embodiments.

FIG. 10 is an illustration of a user interface of an engine, according to some embodiments.

### DETAILED DESCRIPTION

### Overview

Referring generally to the FIGURES, systems and methods for permitting communication in a BMS with a device with an expired operational certificate and replacing the expired security certificate are shown, according to various embodiments. Various devices may connect to and communicate with each other in a BMS. The devices may be, for example, field devices, user interface devices, sensors, actuators, and supervisory devices, or any other component configured to communicate with the BMS. Field devices typically control a specific equipment or a larger system, such as a chilled water system, and may communicate directly with other field devices to coordinate operation. A supervisory device may control higher level building strategies, such as optimization, startup scheduling for a whole floor or building, and high-level monitoring. Field devices may communicate with one or more supervisory devices. Sensors and actuators that are capable of IP communication may also communicate with field devices and supervisory devices.

In order to enable communication between two devices, each device must authenticate the operational certificate of the other. If both certificates are valid, communication between the devices is permitted. If one of the operational certificates has expired, communication will generally not be permitted between the devices. However, there may be circumstances in which it is desired or necessary for a device with an expired operational certificate to continue to communicate with the other devices in the BMS until the certificate can be replaced.

In the disclosed embodiments, an instruction may be sent to the devices in the BMS to accept an expired certificate from one or more specified devices. This allows the specified devices to continue to communicate with the other devices in order to maintain the proper operation of the BMS. A user may connect to the BMS using a user interface device and instruct the other devices to accept specified expired operational certificates as valid. This may function similar to a TLS revocation list, except that, instead of pushing a list of revoked certificates to the devices in the BMS, a temporarily allowed expiration list is pushed to the devices. An instruction may be sent to the devices to ignore the expiration date for operational certificates on the list. When a new, unexpired operational certificate is available for a device, the user may input commands in to the user interface device to replace the expired certificate with a new one. Thus, the operational certificate of a device can be replaced with a valid certificate without the need for a technician to physically perform a factory reset on the device. Once a valid operational certificate has been delivered to the device, connections between the devices may be reset. The device will then possess a valid operational certificate and may communicate with the other devices in the BMS as usual.

### Building Management System

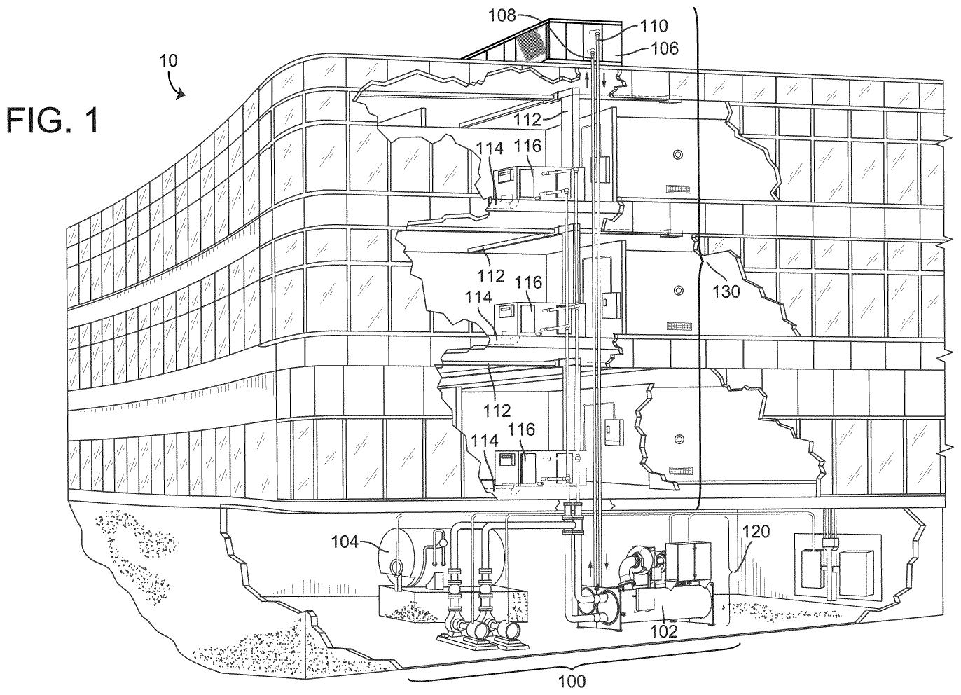

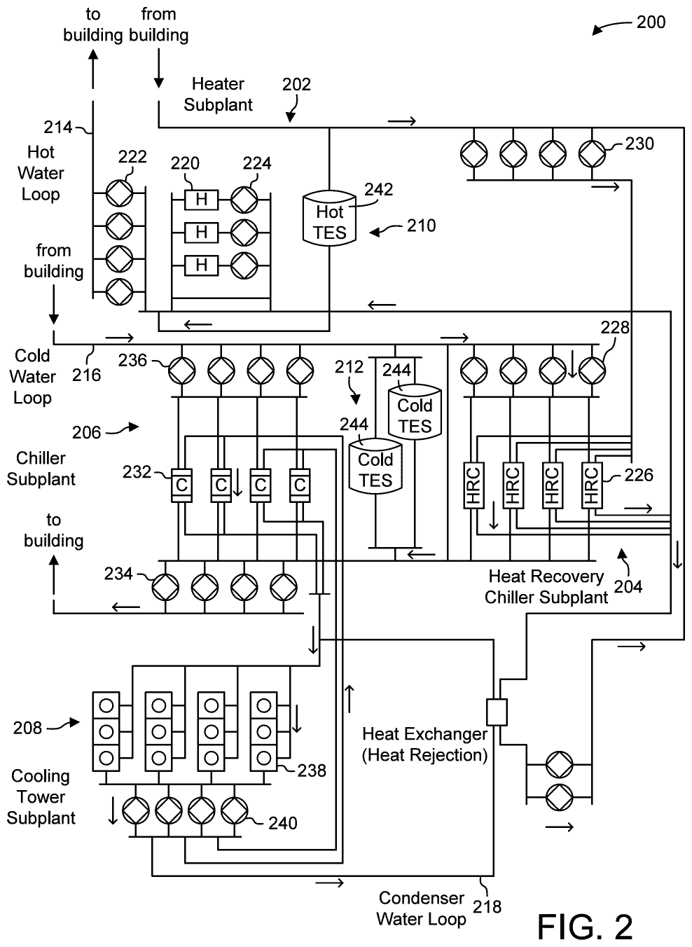

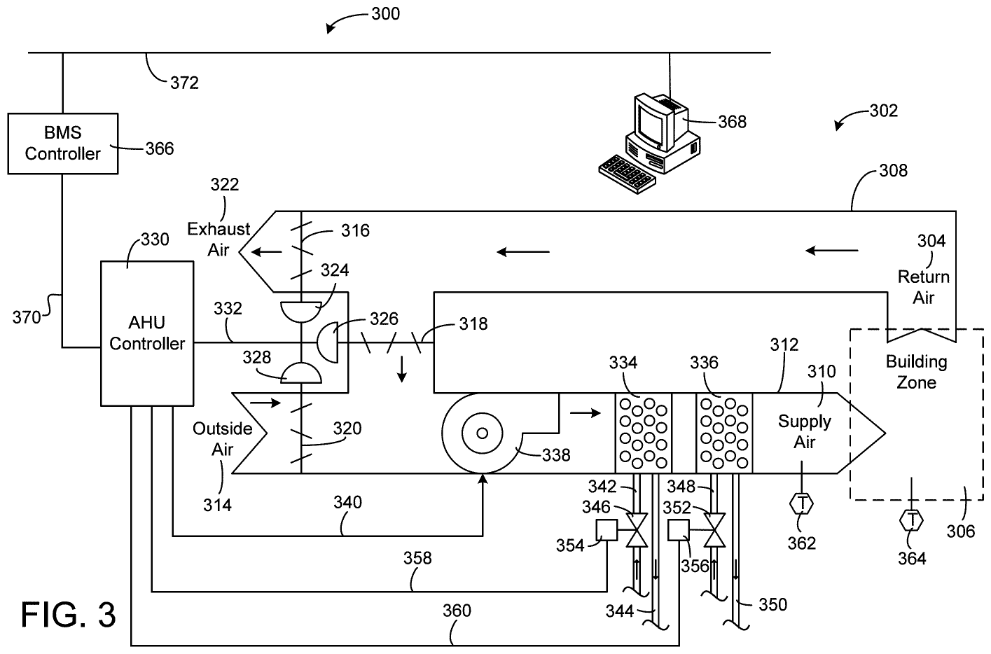

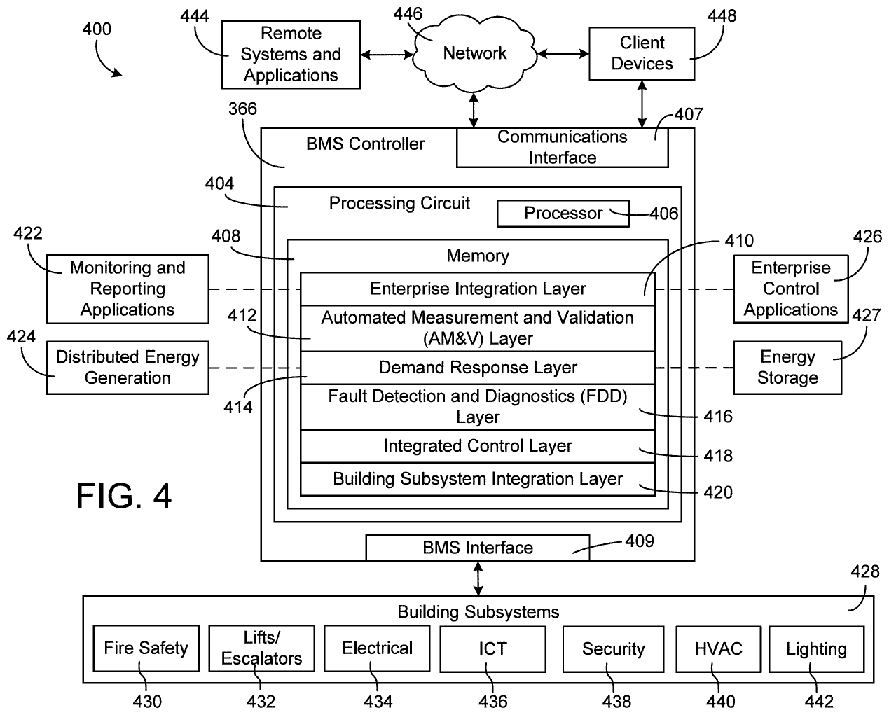

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

Referring particularly to FIG. 1, a perspective view of a building 10 is shown. Building 10 is served by a BMS. A BMS is, in general, a system of devices configured to control, monitor, and manage equipment in or around a building or building area interconnected by a Local Area Network (LAN). A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An example waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

In some embodiments, HVAC system 100 uses free cooling to cool the working fluid. For example, HVAC system 100 can include one or more cooling towers or heat exchangers which transfer heat from the working fluid to outside air. Free cooling can be used as an alternative or supplement to mechanical cooling via chiller 102 when the temperature of the outside air is below a threshold temperature. HVAC system 100 can switch between free cooling and mechanical cooling based on the current temperature of the outside air and/or the predicted future temperature of the outside air.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 and building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

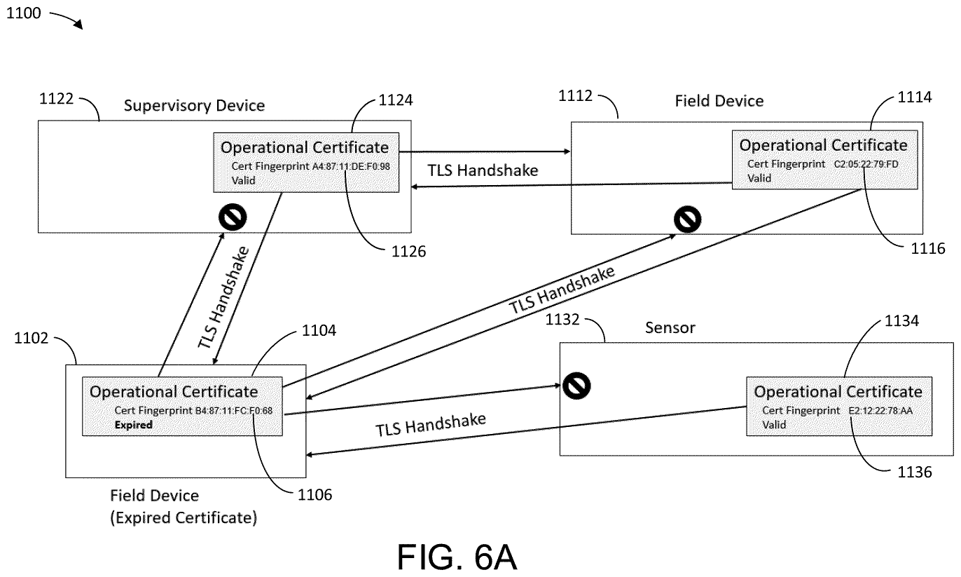

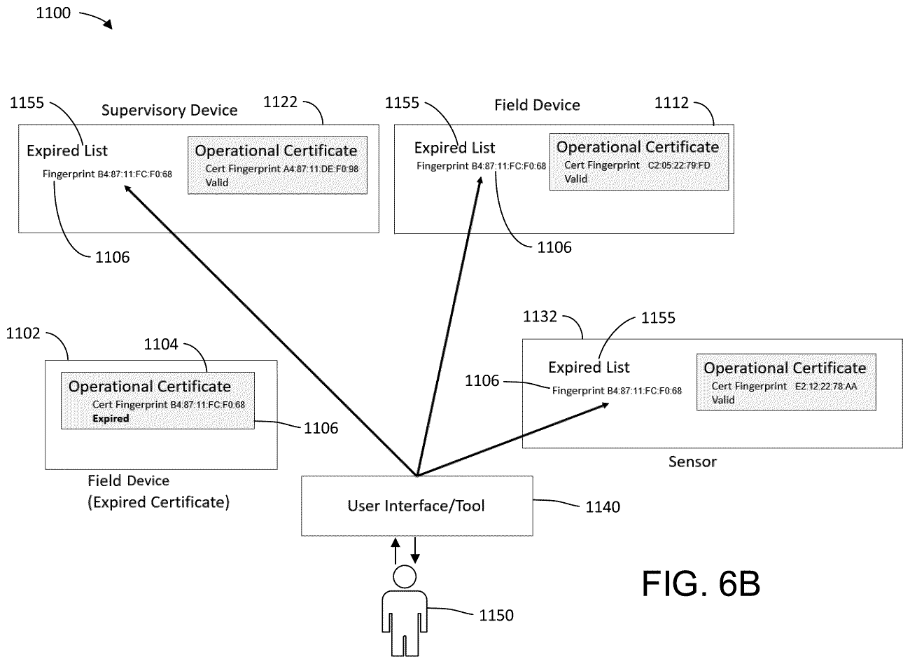

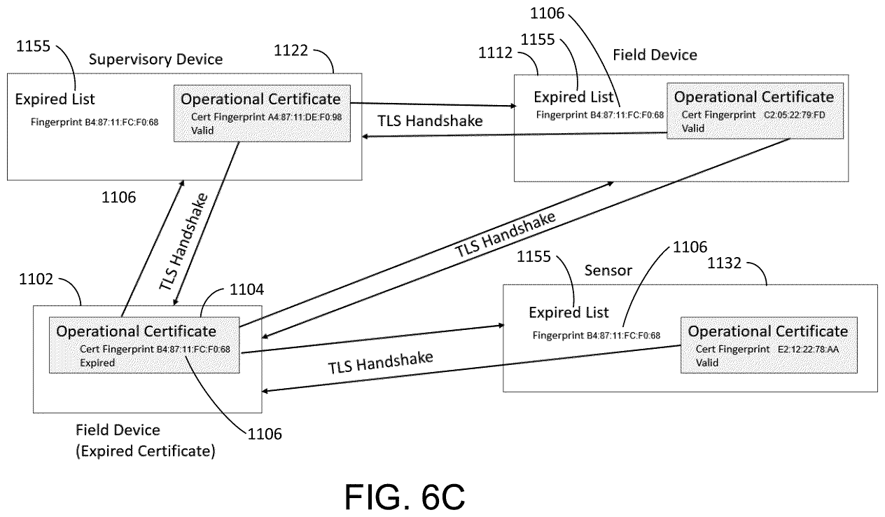

In some embodiments, waterside system 200 uses free cooling to cool the water in cold water loop 216. For example, the water returning from the building in cold water loop 216 can be delivered to cooling tower subplant 208 and through cooling towers 238. Cooling towers 238 can remove heat from the water in cold water loop 216 (e.g., by transferring the heat to outside air) to provide free cooling for the water in cold water loop 216. In some embodiments, waterside system 200 switches between free cooling with cooling tower subplant 208 and mechanical cooling with chiller subplant 208 based on the current temperature of the outside air and/or the predicted future temperature of the outside air. An example of a free cooling system which can be used in waterside system 200 is described in greater detail with reference to FIG. 6.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

In some embodiments, AHU controller 330 uses free cooling to cool supply air 310. AHU controller 330 can switch between free cooling and mechanical cooling by operating outside air damper 320 and cooling coil 334. For example, AHU controller 330 can deactivate cooling coil 334 and open outside air damper 320 to allow outside air 314 to enter supply air duct 312 in response to a determination that free cooling is economically optimal. AHU controller 330 can determine whether free cooling is economically optimal based on the temperature of outside air 314 and/or the predicted future temperature of outside air 314. For example, AHU controller 330 can determine whether the temperature of outside air 314 is predicted to be below a threshold temperature for a predetermined amount of time.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372 (e.g., a LAN).

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, LAN, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Expired Operational Certificate Recovery

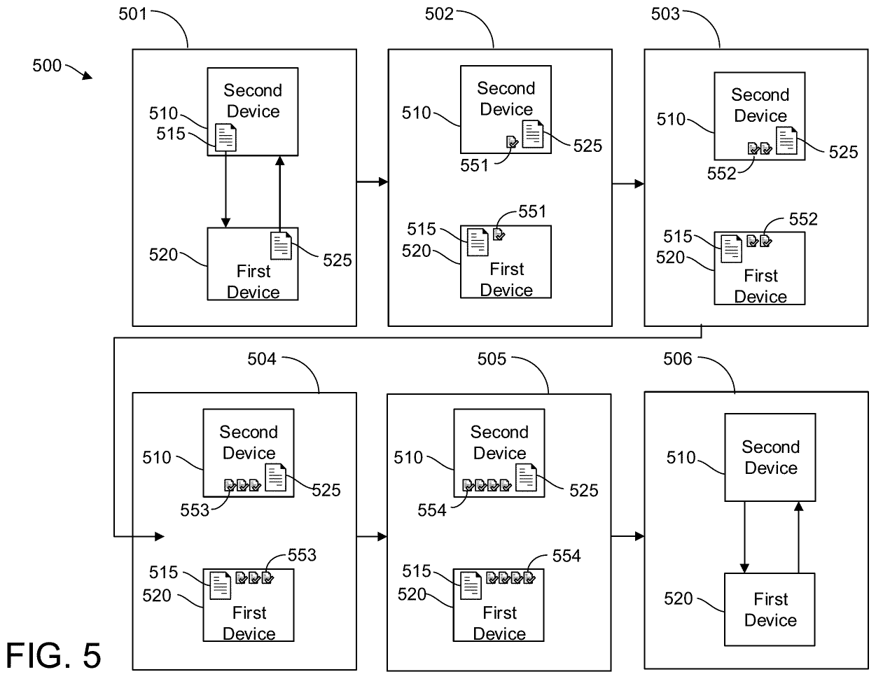

Referring now to FIG. 5, a schematic illustration of a process 500 of mutual TLS authentication of operational certificates between a first device 520 and a second device 510 in a BMS, such as BMS 400, is shown according to an example embodiment. The devices 510, 520 may include one or more processors and one or more computer-readable storage media having instructions stored thereon. The one or more processors may be configured to execute the instructions to perform the actions and processes described herein. A user interface device, such as client device 368, may interface with the devices 510, 520 to provide instructions to the devices 510, 520 and may provide a user interface to the user. The first device 520 may be communicably connected to the second device 510. The first device 520 and second device 510 may communicate securely using a protocol such as TLS. As a non-limiting example, the devices 510, 520 may communicate via secure WebSocket connections as of RFC 6455 and TLS V1.3 as of RFC 8446 for BACnet/SC connections (protocols established by the Internet Engineering Task Force), which provide for confidentiality, integrity, and authenticity of BACnet Virtual Link control (BVLC) messages transmitted across the connection.

The storage media (e.g., memory, memory unit, storage device, etc.) of the devices 510, 520 can include one or more devices (e.g., RAM, ROM, Flash memory, hard disk storage, etc.) for storing data and/or computer code for completing or facilitating the various processes, layers and modules described herein. The storage media can include volatile memory or non-volatile memory. The storage media can include database components, object code components, script components, or any other type of information structure for supporting the various activities and information structures described in the present application. The storage media may be communicably connected to one or more processors and includes computer code for executing one or more processes described herein.

At operation 501, the second device 510 and the first device 520 their respective device operational certificates 515, 525 to each other for validation. At operation 502, the second device 510 and first device 520 each perform a first validation check 551. The second device 510 validates that the first device operational certificate 525 is well formed, and the first device 520 validates that the second device operational certificate 515 is well formed. At operation 503, the second device 510 and first device 520 each perform a second validation check 552. The second device 510 validates that the first device operational certificate 525 is active as of the current date and not expired, and the first device 520 validates that the second device operational certificate 515 is active as of the current date and not expired. At operation 504, the second device 510 and first device 520 each perform a third validation check 553. The second device 510 validates that the first device operational certificate 525 has not been revoked, and the first device 520 validates that the second device operational certificate 515 has not been revoked. At operation 505, the second device 510 and first device 520 each perform a fourth validation check 554. The second device 510 validates that the first device operational certificate 525 is directly signed by one of the locally configured Certificate Authority (CA) certificates, and the first device 520 validates that the second device operational certificate 515 is directly signed by one of the locally configured CA certificates. Each device will trust certificates from a list of one or more trusted CAs stored on the device, and will not trust certificates signed by other CAs. The validation checks 551-554 may occur in any order or simultaneously. Once the validation checks 551-554 are complete, the first device 520 can communicate with the second device 510, as shown in operation 506. Additional validation checks may be performed depending on the needs of the user, such as checks for Common Name, Distinguished Name, Subject Alternate Names, etc.

Operational certificates can be valid for a limited period of time. When a device operational certificate is close to the expiration date, the operational certificate needs to be replaced with a new operational certificate that has an updated expiration date. BMS administrators are generally provided with at least 60 days' notice of an impending operational certificate expiration. However, even with this advance notice, operational certificates are often allowed to expire before being replaced. For example, a device may be offline when the operational certificates of the other devices are replaced. For example, referring still to FIG. 5, in the event the first device operational certificate 525 is expired, the second device 510 will fail to validate the certificate 525 during the second validation check 552. This check will fail on any device that the first device attempts to communicate with, and communication between the first device 520 and the rest of the BMS with be prohibited. Depending on the device, this can cause serious issues in the BMS. Therefore, it would be advantageous for a user to instruct the devices in the system to accept specified expired certificates in order to keep the BMS running properly.

FIGS. 6A-6C illustrate a process for instructing devices in a BMS to accept an expired operational certificate according to an example embodiment. FIG. 6A shows a portion of a BMS 1100 including four devices: (1) a first field device 1102 with a first operational certificate 1104 including a first fingerprint 1106; (2) a second field device 1112 with a second operational certificate 1114 including a second fingerprint 1116; (3) a supervisory device 1122 with a third operational certificate 1124 including a third fingerprint; and (4) a sensor 1132 with a fourth operational certificate 1134 including a fourth fingerprint 1136. A “fingerprint” (or hash) is a number or string generated from a longer string of text (e.g., raw text, a block of computer code, a computer file, etc.). A hash is smaller than the hashed message and is generated by a formula that makes it unlikely that other messages will produce the same hash. Hashes are used with digital signatures to provide additional security in a memory efficient manner since hashes represent a large amount of data as a smaller numeric value. Thus, the hash of the operational certificate is able to identify the operational certificate in a memory-efficient and secure manner.

The first field device 1102 is configured to communicate with each of the other devices 1112, 1122, 1132, and the supervisory device 1122 is also configured to communicate with the second field device 1112. The devices that are configured to communicate with each other attempt a TLS handshake. The TLS handshake may be process 500 described above or a similar process for validating operational certificates. In this example, the first operational certificate 1104 of the first field device 1102 is expired. Therefore, the TLS handshake between the first field device 1102 and the other devices 1112, 1122, 1132 will therefore fail and the first field device will not be permitted to communicate with the other devices 1112, 1122, 1132. Both the supervisory device 1122 and the second field device 1112 have valid operational certificates 1124, 1114, so the TLS handshake between the supervisory device 1122 and the second field device 1112 will succeed and the supervisory device 1122 and the second field device 1112 will be permitted to communicate with each other.

FIG. 6B shows the portion of the BMS 1100 as well as a user 1150 and a user interface device 1140. The user 1150 may receive information from the user interface device 1140 indicating that the first operational certificate 1104 of the first field device 1102 has expired. The user 1150 may input a command to the user interface device 1140 instructing it to push an allowable expired list 1155 to each of the devices 1112, 1122, 1132. The allowable expired list 1155 contains the fingerprints of any expired operational certificates that the user would like the devices to accept. In this example, the allowable expired list 1155 would include the first fingerprint 1106. Thus, the devices 1112, 1122, 1132, would accept the expired first operational certificate 1104 from the first field device. In some embodiments, different allowable expired lists 1155 may be pushed to different devices, depending on the arrangement of the BMS.

FIG. 6C shows the portion of the BMS 1100 after the allowable expired list 1155 has been pushed to the supervisory device 1122, the second field device 1112, and the sensor 1132. Because the first fingerprint 1106 is on the allowable expired list 1155, the TLS handshakes between the first field device 1102 and the other devices 1112, 1122, 1132 are successful and communication between the first field device 1102 and the other devices 1112, 1122, 1132 is permitted. The user 1150 may define how long the allowable expired list 1155 should remain on the devices 1112, 1122, 1132 via the user interface device 1140. Alternatively, the user 1150 may push the allowable expired list 1155 to the devices 1112, 1122, 1132 via the user interface device 1140 and may remove or alter the list via the user interface device 1140 as needed. Generally, expired operational certificates should be accepted only for a limited time and should be replaced by a new certificate when possible. A user 1150 may use a user interface device 1140 to connect to a device with an expired operational certificate, such as field device 1102, with a new certificate. The user interface device 1140 and the field device 1102 must perform mutual authentication to communicate with each other. The field device 1102 may authenticate a certificate from the user interface device 1140, and the user interface device 1140 must authenticate the operational certificate 1104 from the field device 1102. The user interface device 1140 may be configured to accept the expired operational certificate 1104 as valid. Once the certificates are authenticated, the user interface device 1140 may communicate with the field device 1102 and the user interface device 1140 may replace the expired operational certificate 1104 with a new operational certificate. It should be understood that the operations of the process described in FIGS. 6A-6C may take place in different orders or simultaneously, or make take place at different times. Specifically, the BMS may operate using devices with expired certificates for days or weeks before replacement operational certificates are delivered to those devices.

In some circumstances, a user interface device 1140 may not be able to communicate directly with a device and must communicate with the device through another device. For example, a field device, such as field device 1102, may only be able to communicate with a user interface device 1140 through a supervisory device, such as supervisory device 1122. In that case, the supervisory device 1122 may be instructed to accept the expired operational certificate 1104 of the field device 1102 as valid using the methods described herein, thus permitting communication between the supervisory device 1122 and the field device 102. Then, the user interface device 1140 may instruct the supervisory device 1122 to replace the expired operational certificate 1104 with a new certificate.

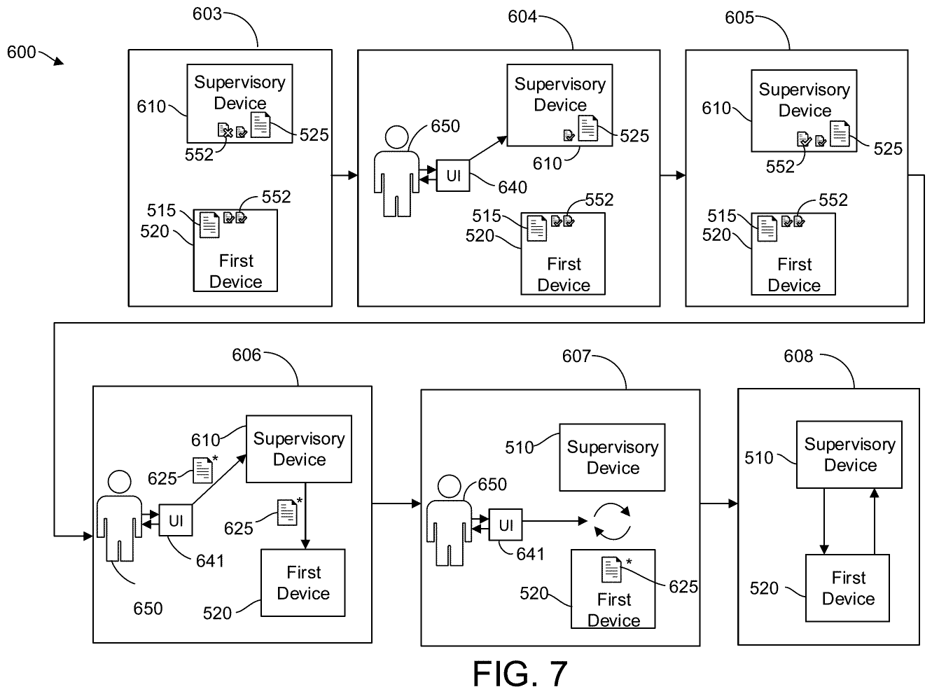

FIG. 7 illustrates a process 600 for replacing an expired operational certificate on a device according to an example embodiment. At operation 603, the supervisory device 610 performs a second validation check 552 on the first device operational certificate 525 that has been sent to it by the first device 520. In this case, the second validation check 552 has failed because the first device operational certificate 525 has expired. Each device 510, 520 may perform additional validation checks to determine that the second validation check 522 is the only validation check that failed, indicating that the only issue preventing communication between the devices 510, 520 is that the first device operational certificate 525 is expired. At operation 604, a user 650 may log into a user interface device 640. The user 650 may enter commands into the user interface device 540 instructing the user interface device 640 to send a command to the second device 510 to accept the expired first device operational certificate 525. The user interface device 640 may push a list of allowable expired certificate fingerprints to the second device 510 that includes the fingerprint of the first device operational certificate 525. At operation 605, the engine again performs a second validation check 552, this time also checking the allowable expired list, and accepts the fingerprint of the expired first device operational certificate 525 as if it were unexpired.

In this example embodiment, the first device 520 is not capable of communicating directly with the user interface device 640. At operation 606, the user 650, via a user interface device 640, may load a replacement device operational certificate 625 to the first device 520. The user interface device 641 may be the same device as user interface device 640, or may be a different device. For example, the user interface device 640 may be capable of instructing devices in the BMS to accept expired operational certificates, but may not be configured to replace expired operational certificates with new operational certificates. If that is the case, the user interface device 641 may be a different device that is able to replace the expired operational certificates. The replacement device operational certificate 625 may be stored on the first device 520 and may replace the original first device operational certificate 525. At operation 607, the user 650 may enter a command into the user interface device 640 to reset the connection between the first device 520 and the second device 510 by closing and reopening the connection. The TLS protocol and other security protocols may require this reset in order for the second device 510 to accept the replacement device operational certificate 625. The second device operational certificate 515 may remain valid during the replacement of the first device operational certificate 525 and the resetting of the connection. The first device 520 may then perform the validation checks 551-554 on the second device operational certificate 515 and the engine may perform the validation checks 551-554 on the replacement device operational certificate 625, as described in process 500. Communication between the second device 510 and the first device 520 may then be allowed, as shown in operation 608.

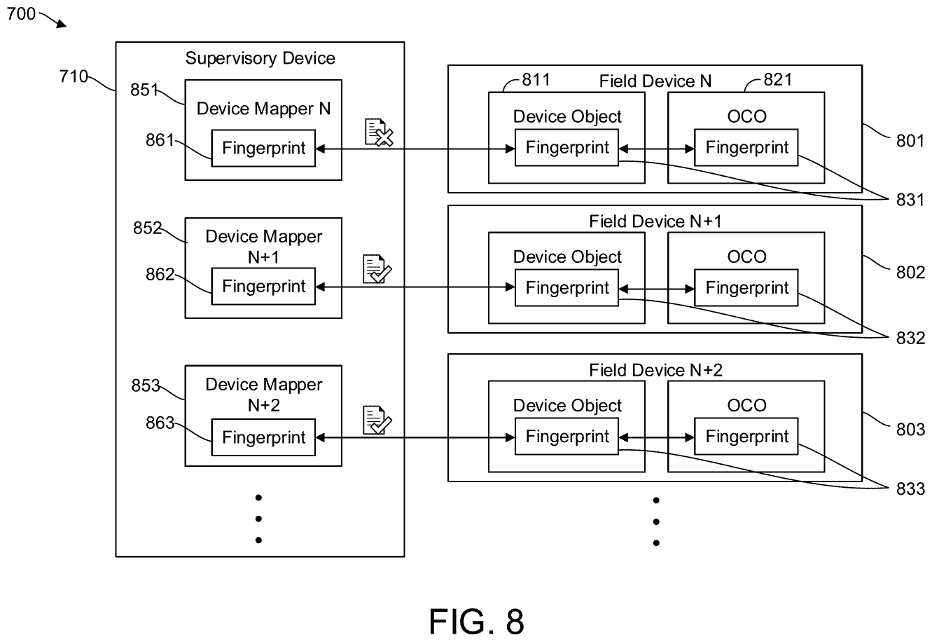

FIG. 8 is a schematic diagram of a workflow and object interaction 700 between a supervisory device 710 and a plurality of field devices, e.g., field devices 801-803, according to an example embodiment. A supervisory device may be connected to any number of field devices. Each field device includes a device object and an Operational Certificate Object (OCO), each containing a fingerprint, or hash, of the device operational certificate. For example, field device 801 includes a device object 811 and an OCO 821 which share fingerprint 831. The supervisory device 710 includes a plurality of device mappers, each mapped to one field device. For example, device mapper 851 is mapped to field device 801, device mapper 852 is mapped to field device 802, and device mapper 853 is mapped to field device 803. Additional field devices connected to the supervisory device 710 would each require an additional device mapper.

In this example, each device mapper includes a known fingerprint that the device mapper compares to the fingerprint received from a field device to confirm that the field device is permitted to connect to the BMS. For example, device mapper 851 includes known fingerprint 861. When a field device is successfully mapped to a supervisory device, the device mapper will receive the fingerprint, or hash, of the operational certificate for the field device. The device mapper compares the known fingerprint to the fingerprint it receives from the field device. If the fingerprint from the field device matches the known fingerprint and the fingerprint is not expired, the field device is permitted to communicate with the supervisory device. For example, device mapper 852 has compared the fingerprint 832 of its corresponding field device 802 to its known fingerprint 862 and determined that the fingerprints match. Similarly, device mapper 853 has determined that fingerprint 833 from field device 803 matches known fingerprint 863. Accordingly, field devices 802 and 803 are permitted to communicate with the second device 510.

However, if the field device certificate has expired, the supervisory device will inspect the fingerprint, determine from the fingerprint that the operational certificate is expired, and the reject the connection. For example, device mapper 851 compares known fingerprint 861 to the fingerprint 831 that it receives from the field device 801 and determines that they match, but refuses the connection because the fingerprint indicates that the operational certificate has expired. The field device 801 will then be prohibited from communicating with the supervisory device 710. The field device 801 may appear offline to a user via a user interface (e.g., user interface 900) and an attribute list may indicate to the user that the reason the field device is offline is because the operational certificate is expired. When a user sees an indication that one or more of the field devices is offline due to an expired operational certificate, the user may instruct the supervisory device 710 to accept expired operational certificates,

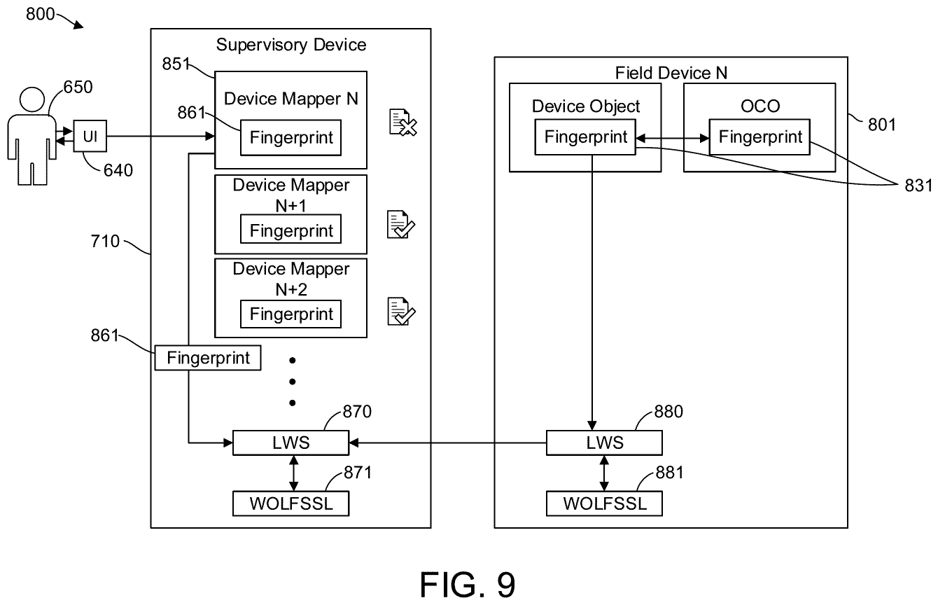

FIG. 9 is a schematic representation of a workflow and object interaction 800 during the CPR diagnostic process, according to an example embodiment. The user 650 sends a command via user interface device 640 to each device mapper that is indicating a field device is offline. For example, the user 650 in FIG. 8 has selected device mapper 851. Device mapper 851 can send its known fingerprint 861 to the Libwebsockets (LWS) layer 870 of the supervisory device 710. The LWS layer 870 is a third-party library that enables a websocket connection between the supervisory device 710 and the field devices. For example, the LWS layer 870 may form a websockets connection with the LWS layer 880 of field device 801. The LWS layers 870, 880 may each be connected to a WOLFSSL library 871, 881, or any another embedded SSL/TLS library containing a cryptography engine capable of securely decoding the fingerprints. The LWS layer 870 includes a callback handler that will then compare the known fingerprint to the fingerprint received from the corresponding field device. For example, LWS layer 870 includes a callback handler that can compare the known fingerprint 861 to the fingerprint 831 received from field device 801.

If the LWS callback handler determines that the fingerprint from the field device otherwise matches the known fingerprint stored in the device mapper, the LWS callback handler can then determine the callback reason, i.e., the reason why the field device connection was rejected. If the LWS callback handler determines that the field device connection was rejected due to an expired certificate, the supervisory device 710 can relax the date constraint and accept the expired certificate. The supervisory device may remove the expiration date constraint entirely or may adjust the expiration date by a fixed amount of time. For example, the supervisory device 710 may extend the expiration date by only one month in order to accept only operational certificates that have recently expired (i.e., in the past month). The device mapper will then indicate to the user that the field device is back online. The user may then instruct the supervisory device 710 to load a replacement device operational certificate onto the field device. BACnet and other security protocols may require that connections between the supervisory device 710 and any field devices with replacement operational certificates be closed and re-established to ensure that the replacement device operational certificate is being used. The field device 801 may temporarily appear offline to the user while the connection is reset. Once the new connection has been established, the known fingerprint in the device mapper is replaced by a new fingerprint corresponding to the replacement device operational certificate. The device operational certificate fingerprint should then match the known fingerprint, and the field device 801 can communicate with the supervisory device 710. The engine will then indicate that the field device is online. It should be understood that the embodiment shown in FIG. 9 can be performed on any device capable of communicating with the user interface device 640, and is not limited to supervisory devices.

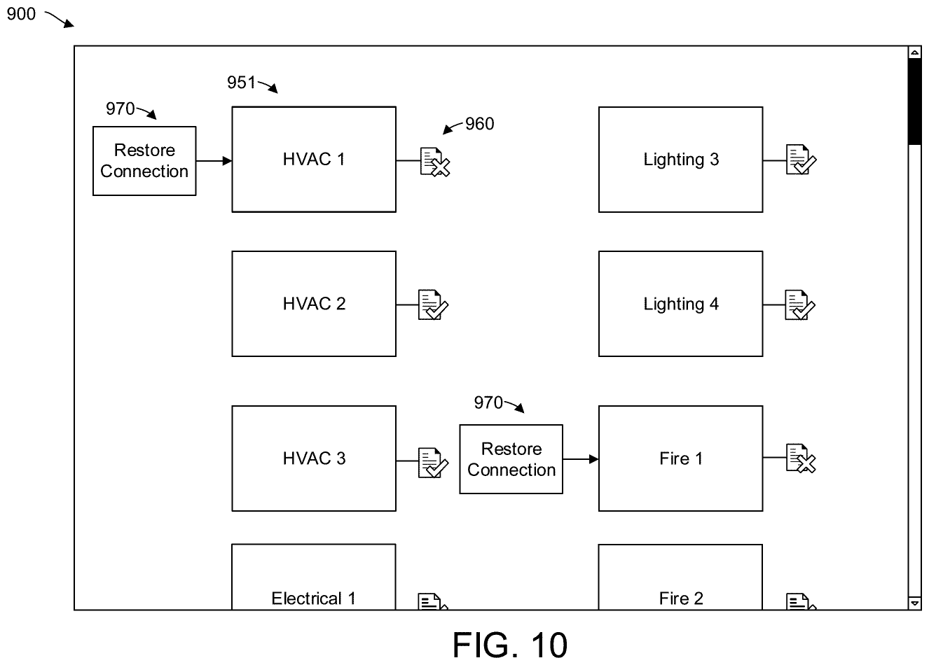

Referring to FIG. 10, a user interface 900 associated with BMS 400 and the processes described herein is shown, according to an example embodiment. User interface 900 may be displayed on a screen of a user interface device, such as user interface device 640 or client device 368. User interface 900 may include a plurality of device icons 951, each representing a device in the BMS. Additional device icons 951 may appear below the icons shown when a user scrolls down on the GUI. The device icons 951 may include various information about the corresponding field device, for example, the name of the field device, the model number of the field device, the system the field device is configured to control (e.g., HVAC, Electrical, Fire Detection, Lighting, etc.), the location of the field device, the device operational certificate expiration date, etc. In some embodiments, the user may be able to click or select a device icon 951 to see additional information about the corresponding field device, adjust settings or enter information relating to the corresponding device, disconnect or reconnect a device, replace the operational certificate of the device prior to the expiration date, or perform other functions relating to the selected device. In some embodiments a user may be able to select a device icon 951 corresponding to a device with an expired operational certificate and instruct the other devices in the BMS to enable communication to the device or with the expired certificate. The user may be replace the expired certificate once a new one is available.

Each device icon 951 may have a connection status indicator icon 960 that signals whether or not the device corresponding to that device icon 951 is able to communicate with the other devices in the BMS. A restore connection icon 970 may appear next to the device icon 951 of a device that is unable to communicate with the other devices. A user may click or select the restore connection icon 970 in order to add the fingerprint of the operational certificate of field device corresponding to the device icon 951 to the allowable expired list 1155, according to the embodiments described above. The allowable expired list 1155 may then be pushed to the other devices in the system, instructing the devices to relax or ignore the expiration date of operational certificate fingerprints on the allowable expired list 1155. The other devices may then accept the fingerprint of any expired operational certificates that are on the allowable expired list 1155 and communication may be restored.

### Configuration of Example Embodiments

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the example embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method of reconnecting a device with an expired device operational certificate in a building management system (BMS), the method comprising:
identifying that a device operational certificate of a first device has expired;
sending an instruction to a second device to accept the expired device operational certificate as valid, receipt of the instruction causing the second device to relax an expiration date and accept the expired device operational certificate as valid; and
delivering a replacement device operational certificate to the first device to replace the expired device operational certificate.

2. The method of claim 1, further comprising receiving an indication from the second device that each of one or more other attributes of the device operational certificate indicate that the device operational certificate would otherwise be valid if not for being expired, wherein accepting the expired operational certificate as valid is performed in response to determining that the certificate would have otherwise been valid if not for being expired.

3. The method of claim 2, wherein the one or more other attributes comprise the device operational certificate being well formed, the device operational certificate not having been revoked, or the device operational certificate having been signed by a locally configured certificate authority (CA).

4. The method of claim 1, wherein identifying that the device operational certificate of the first device has expired comprises receiving an indication from the first device or second device that the device operational certificate has expired.

5. The method of claim 1, wherein relaxing the expiration date to accept the expired device operational certificate as valid comprises one of removing an expiration date to accept an expired operational certificate or adjusting the expiration date to accept an operational certificate that is expired by less than a predetermined amount of time.

6. The method of claim 1, wherein delivering the replacement device operational certificate to the first device to replace the expired device operational certificate comprises retrieving the replacement device operational certificate from a locally configured CA.

7. The method of claim 1, further comprising:
resetting a connection between the first device and the second device; and
validating the replacement device operational certificate.

8. The method of claim 1, wherein sending an instruction to the second device comprises sending an allowable expired list of device operational certificate fingerprints that are acceptable even if expired.

9. A BMS comprising:
a first device comprising a device operational certificate; and
a second device comprising one or more processors and one or more computer-readable storage media having instructions stored thereon that, when executed by the one or more processors, cause the one or more processors to implement operations comprising:
identifying that the device operational certificate of the first device has expired;
receiving an instruction to accept the expired device operational certificate as valid; and
relaxing an expiration date requirement to accept the expired device operational certificate as valid.

10. The BMS of claim 9, wherein the operations further comprise confirming that each of one or more other attributes of the device operational certificate indicate that the device operational certificate is valid.

11. The BMS of claim 10, wherein the one or more other attributes comprise the device operational certificate being well formed, the device operational certificate not having been revoked, or the device operational certificate having been signed by a locally configured certificate authority (CA).

12. The BMS of claim 9, wherein identifying that the device operational certificate of the first device has expired comprises receiving, from the first device, a fingerprint of the device operational certificate.

13. The BMS of claim 9, wherein relaxing the expiration date requirement to accept the expired device operational certificate as valid comprises one of removing an expiration date to accept an expired operational certificate or adjusting the expiration date to accept an operational certificate that is expired by less than a predetermined amount of time.

14. The BMS of claim 9, wherein the BMS further comprises a user interface device comprising a user interface configured to display a plurality of icons, each corresponding to one of one or more devices and configured to indicate a connection status of each of the one or more devices.

15. The BMS of claim 14, wherein the user interface device is configured to send an instruction to one or more devices in the BMS to accept the expired device operational certificate as valid.

16. The BMS of claim 9, wherein receiving an instruction to accept the expired device operational certificate as valid comprises receiving an allowable expired list of device operational certificate fingerprints that are acceptable even if expired.

17. A method of replacing an expired device operational certificate, the method comprising:
identifying that a device operational certificate of a first device has expired;
receiving an instruction from a user interface device to accept the device operational certificate that has expired as valid;
relaxing an expiration date requirement and accepting the expired device operational certificate as valid;
receiving a replacement device operational certificate from the user interface device; and
delivering the replacement device operational certificate to the first device.

18. The method of claim 17, wherein receiving an instruction from a user interface device to accept the device operational certificate that has expired as valid comprises receiving an allowable expired list of device operational certificate fingerprints that are acceptable even if expired.

19. The method of claim 18, further comprising confirming that the replacement device operational certificate is valid.

20. The method of claim 19, further comprising communicatively connecting to the first device in response to confirming that the replacement device operational certificate is valid.
